(19) United States
(12) Patent Application Publication
(10) Pub. No.: US 2025/0038867 A1
(43) Pub. Date: Jan. 30, 2025

(54) COMMUNICATION DEVICE AND VALID SIGNAL DETECTION METHOD

(71) Applicant: REALTEK SEMICONDUCTOR CORPORATION, Hsinchu (TW)

(72) Inventors: LI-HUA WANG, Suzhou (CN); Ming-Zhi Guo, Suzhou (CN)

(21) Appl. No.: 18/780,560

(22) Filed: Jul. 23, 2024

(30) Foreign Application Priority Data
Jul. 25, 2023 (CN) 202310916880.6

(51) Int. Cl. H04B 17/336

(52) U.S. Cl. CPC H04B 17/336

(57) ABSTRACT

A valid signal detection method includes the following operations: utilizing a first period to calculate a delay correlation function of a communication signal to determine a first delay correlation information; utilizing a second period to calculate the delay correlation function of the communication signal to determine a second delay correlation information, in which the first period is greater than the second period; and determining whether the communication signal is interference according to the first delay correlation information and the second delay correlation information.

### BACKGROUND OF THE INVENTION

### 1. Field of the Invention

The present disclosure relates to a communication device, especially to a communication device and a valid signal detection method thereof that are able to utilize a delay correlation to determine whether a currently received signal is interference.

### 2. Description of Related Art

In practical applications, the communication signals received by communication systems are typically valid signals, interference, or a combination of both. As a valid signal often contains symbols with periodicity, the communication system may detect whether the received communication signal is a valid signal based on delay correlation. However, if the interference in the environment is a direct current (DC) signal or a periodic signal, the detection results of delay correlation may be affected to mistakenly determine the interference as a valid signal, leading to a reduction in system performance.

### SUMMARY OF THE INVENTION

In some aspects of the present disclosure, an object of the present disclosure is, but not limited to, provide a communication device and a valid signal detection method thereof that are able to utilize a delay correlation to determine whether the currently received signal is interference, so as to make an improvement to the prior art.

In some aspects of the present disclosure, a communication device includes a receiver circuit and a processor circuit. The receiver circuit is configured to receive a communication signal. The processor circuit is configured to utilize a first period to calculate a delay correlation function of the communication signal to determine a first delay correlation information, utilize a second period to calculate the delay correlation function of the communication signal to determine a second delay correlation information and determine whether the communication signal is interference according to the first delay correlation information and the second delay correlation information, in which the first period is greater than the second period.

In some aspects of the present disclosure, a valid signal detection method includes the following operations: utilizing a first period to calculate a delay correlation function of a communication signal to determine a first delay correlation information; utilizing a second period to calculate the delay correlation function of the communication signal to determine a second delay correlation information, in which the first period is greater than the second period; and determining whether the communication signal is interference according to the first delay correlation information and the second delay correlation information.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a communication device according to some embodiments of the present disclosure.

FIG. 2 illustrates a flowchart of a valid signal detection method according to some embodiments of the present disclosure.

FIG. 3 illustrates a schematic diagram of results from simulations (or measurements) performed on the communication device in FIG. 1 according to some embodiments of the present disclosure.

FIG. 4A illustrates a flowchart of one operation in FIG. 2 according to some embodiments of the present disclosure.

FIG. 4B illustrates a flowchart of one operation in FIG. 2 according to some embodiments of the present disclosure.

FIG. 5 illustrates a flowchart of one operation in FIG. 2 according to some embodiments of the present disclosure

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system formed with one or more circuits, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

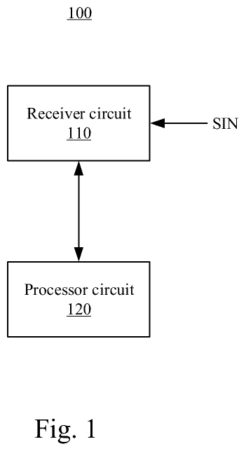

FIG. 1 illustrates a schematic diagram of a communication device 100 according to some embodiments of the present disclosure. In some embodiments, the communication device 100 may be, but is not limited to, a wireless communication device. The communication device 100 includes a receiver circuit 110 and a processor circuit 120. In some embodiments, the receiver circuit 110 may be, but is not limited to, a circuit used for receiving signals in a transceiver (not shown) of the communication device 100. In some embodiments, the processor circuit 120 may be implemented with, but is not limited to, at least one microcontroller circuit and/or at least one digital signal processor circuit with computing capability, but the present disclosure is not limited thereto.

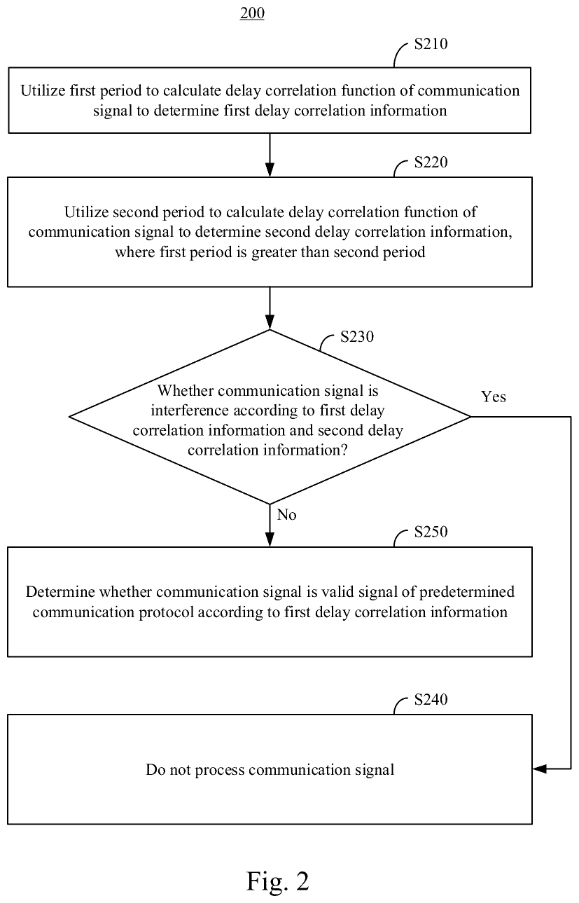

The receiver circuit 110 may receive a communication signal SIN. The processor circuit 120 is coupled to the receiver circuit 110 to receive the communication signal SIN and perform operations described in FIG. 2 according to the communication signal SIN, thereby determining whether the communication signal SIN currently received by the receiver circuit 110 is interference. If the communication signal SIN is determined to be interference, the processor circuit 120 may discard the currently received communication signal SIN without performing subsequent signal processing. If the communication signal SIN is determined to be a valid signal (i.e., it is determined that the communication signal SIN is not interference), the processor circuit 120 may further determine whether the communication signal SIN is a packet of a predetermined communication protocol, thereby selectively performing corresponding signal processing on the communication signal SIN.

FIG. 2 illustrates a flowchart of a valid signal detection method 200 according to some embodiments of the present disclosure. In some embodiments, operations of the valid signal detection method 200 may be executed by the processor circuit 120 in FIG. 1, but the present disclosure is not limited thereto.

In operation S210, a first period (e.g., a first period L1 as mentioned below) is utilized to calculate the delay correlation function of the communication signal (e.g., the communication signal SIN in FIG. 1) to determine the first delay correlation information. In operation S220, a second period (e.g., the second period L2 mentioned below) is utilized to calculate the delay correlation function of the communication signal to determine the second delay correlation information, where the first period is greater than the second period. In operation S230, whether the communication signal is interference is determined according to the first delay correlation information and the second delay correlation information. If the communication signal is determined to be interference, operation S240 is performed. If the communication signal is determined not to be interference, operation S250 is performed. In operation S240, the communication signal is not processed. In operation S250, whether the communication signal is a valid signal of a predetermined communication protocol is determined according to the first delay correlation information. In some embodiments, the detailed calculation of operation S250 may refer to the algorithm of the existing delay correlation function. For example, as mentioned below, in some embodiments, the first delay correlation information may include a first delay correlation output value and a first threshold value. Under this condition, the processor circuit 120 may perform operation S250 to determine whether the first delay correlation output value is greater than the product of the first threshold value and the first period. If the first delay correlation output value is greater than this product, the processor circuit 120 may determine that the communication signal SIN is a valid signal of the predetermined communication protocol and, accordingly, perform subsequent data processing on the communication signal SIN.

Operations of the valid signal detection method 200 can be understood with reference to various embodiments. Operations shown in FIG. 2 include exemplary steps, but those steps are not necessarily performed in the order described above. Operations of the valid signal detection method 200 may be added, replaced, changed order, and/or eliminated, or the operations of the valid signal detection method 200 may be performed simultaneously or partially simultaneously as appropriate, in accordance with the spirit and scope of various embodiments of the present disclosure.

To facilitate the understanding of operations S210, S220, and S230 of the valid signal detection method 200, a mathematical model of a delay correlation function is described below (but the present disclosure is not limited thereto). In some embodiments, the delay correlation function may be expressed as the following equation (1):

$$C ( t ) = {\sum }_{n = t}^{τ + t - 1} {r}_{i , n} \cdot {r}_{i , n - τ}^{*} \qquad ( 1 )$$

where r_{i,n} indicates the communication signal SIN received by the i-th antenna (not shown in FIG. 1) of the communication device 100 at the n-th time point, and τ is the period of a preamble sequence. In the equation (1), the communication signal SIN is expressed in a complex form with real and imaginary parts (i.e., r_{i,n}), which includes information about the signal amplitude and phase. This is well understood by those skilled in the relevant field, and thus not further elaborated. Moreover, in equation (1), r*_{i,n-τ} is the complex conjugate of r_{i,n-τ}.

As mentioned above, the processor circuit 120 may utilize the first period to calculate the delay correlation function of the communication signal SIN to determine the first delay correlation information (i.e., operation S210 in FIG. 2). In some embodiments, the first period may be the period of a symbol in the preamble defined within the predetermined communication protocol employed by the communication device 100. For example, the aforementioned predetermined communication protocol may be IEEE 802.15.4. In this protocol, the preamble of a valid signal packet includes 8 identical symbols, each with a period of 16 microseconds (μs). Under these conditions, the first period may be set to approximately 16 microseconds. In some embodiments, the first delay correlation information may include the first delay correlation output value and/or the first threshold value. In greater detail, the processor circuit 120 may obtain an output value C(t) based on the delay correlation function of the equation (1), accumulate this output value C(t) by the first period, and calculate the square of the accumulated result to generate the first delay correlation output value. The above operations may be expressed as the following equation (2):

$$O 1 = {( {\sum }_{t = 0}^{L 1 - 1} C ( t ) )}^{2} \qquad ( 2 )$$

where O1 is the first delay correlation output value, and L1 is the first period.

In some embodiments, the processor circuit 120 may obtain an output value C(t) based on the delay correlation function of equation (1), accumulate the square of this output value C(t) by the first period, and calculate the square of the accumulated result to generate the first threshold value. The above operations may be expressed as the following equation (3):

$$TH 1 = {\sum }_{t = 0}^{L 1 - 1} {C ( t )}^{2} \qquad ( 3 )$$

where TH1 is the first threshold value.

Similarly, the second delay correlation information may include the second delay correlation output value and/or the second threshold value. The processor circuit 120 may utilize the same calculations with the second period to obtain the second delay correlation output value and the second threshold value, which may be respectively expressed as the following equations (4) and (5):

$$O 2 = {( {\sum }_{t = 0}^{L 2 - 1} C ( t ) )}^{2} \qquad ( 4 )$$

$$TH 2 = {\sum }_{t = 0}^{L 2 - 1} {C ( t )}^{2} \qquad ( 5 )$$

where O2 is the second delay correlation output value, TH2 is the second threshold value, and L2 is the second period. In some embodiments, the first period L1 is set to be greater than the second period L2. As previously mentioned, the first period L1 may be set to approximately 16 microseconds. In this example, the second period L2 may be set to, but is not limited to, approximately 8 microseconds.

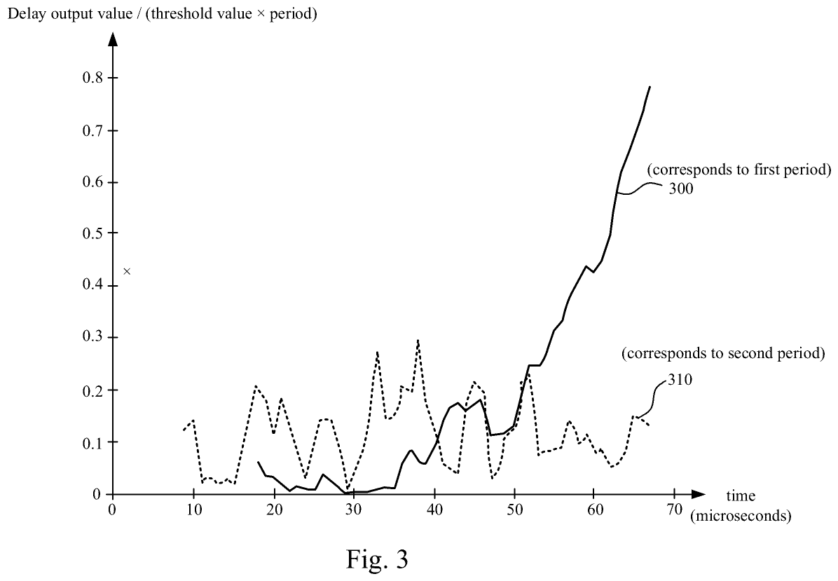

FIG. 3 illustrates a schematic diagram of the results from simulations (or measurements) performed on the communication device 100 in FIG. 1 according to some embodiments of the present disclosure. In some experimental examples, the predetermined communication protocol is the aforementioned IEEE 802.15.4, with the first period L1 set to approximately 16 microseconds, the second period L2 set to approximately 8 microseconds, and the power of the communication signal SIN set to approximately −99 decibels-milliwatts (dBm). By conducting simulations and/or measurements on the communication device 100 based on the aforementioned parameter settings, the related results shown in FIG. 3 may be obtained. In FIG. 3, the horizontal axis indicates time (in microseconds), and the vertical axis indicates the ratio between the delay correlation output value and a specific product, where the specific product may be the product of the corresponding threshold value and the corresponding period. For example, the value of a line segment 300 is the ratio between the first delay correlation output value O1 and the product of the first threshold value TH1 and the first period L1, which may be expressed as O1/(TH1×L1), and the value of a line segment 310 is the ratio between the second delay correlation output value O2 and the product of the second threshold value TH2 and the second period L2, which may be expressed as O2/(TH2×L2).

In the experimental example of FIG. 3, the communication device 100 receives the communication signal SIN after approximately 32 microseconds. As shown in FIG. 3, after 32 microseconds, the value of the line segment 300 increases significantly, while the value of the line segment 310 remains in a lower value range. As the line segment 300 is generated based on the first delay correlation information, and the first delay correlation information is generated based on the first period L1 which is the same as the symbol period of the communication signal SIN, the value of the line segment 300 begins to increase in response to the period correlation when the communication signal SIN with the same period is received. Conversely, as the line segment 310 is generated based on the second delay correlation information, and the second delay correlation information is generated based on the second period L2 which is less than the symbol period of the communication signal SIN, the value of the line segment 310 remains in a lower value range in response to the period disparity. Therefore, from FIG. 3, it may be derived that when the communication signal SIN belongs to a valid signal defined in the predetermined communication protocol, the value of the line segment 300 obtained based on the first delay correlation information (corresponding to the first period L1) will be significantly higher than the value of the line segment 310 obtained based on the second delay correlation information (corresponding to the second period L2).

On the other hand, in the aforementioned experimental example, if the communication signal SIN is replaced with an additive white Gaussian noise (AWGN), the result would show that the value of the line segment 300 is close to (or the same as) the value of the line segment 310. In other words, when the communication device 100 receives the communication signal SIN that is primarily noise, or when the communication signal SIN received by the communication device 100 is merely interference caused by other devices, the value of the line segment 300 obtained based on the first delay correlation information (corresponding to the first period will be close to the value of the line segment 310 obtained based on the second delay correlation information (corresponding to the second period). That is, when the communication signal SIN is a DC (direct current) signal or noise(s), no matter which value of the period is utilized for calculation, the obtained delay related information will be close to each other. Based on the above, the processor circuit 120 may determine whether the communication signal SIN is interference according to the first and the second delay related information.

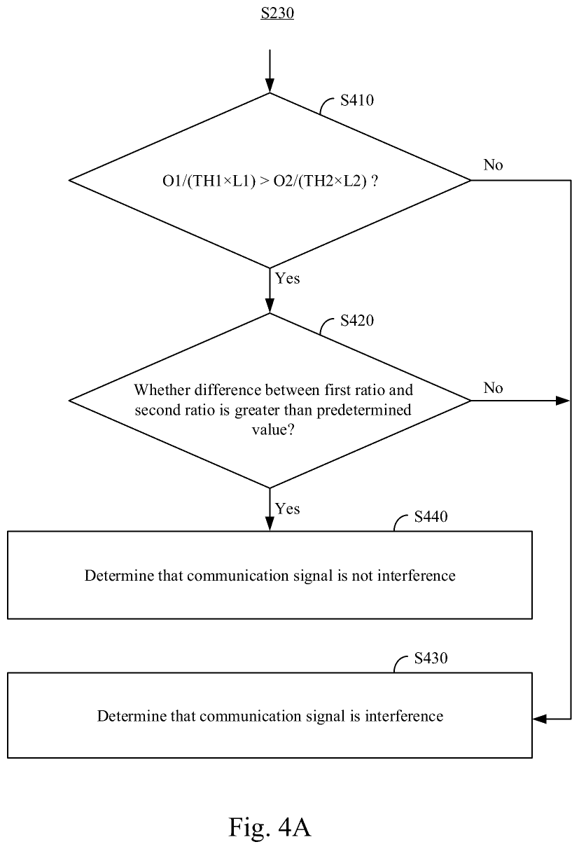

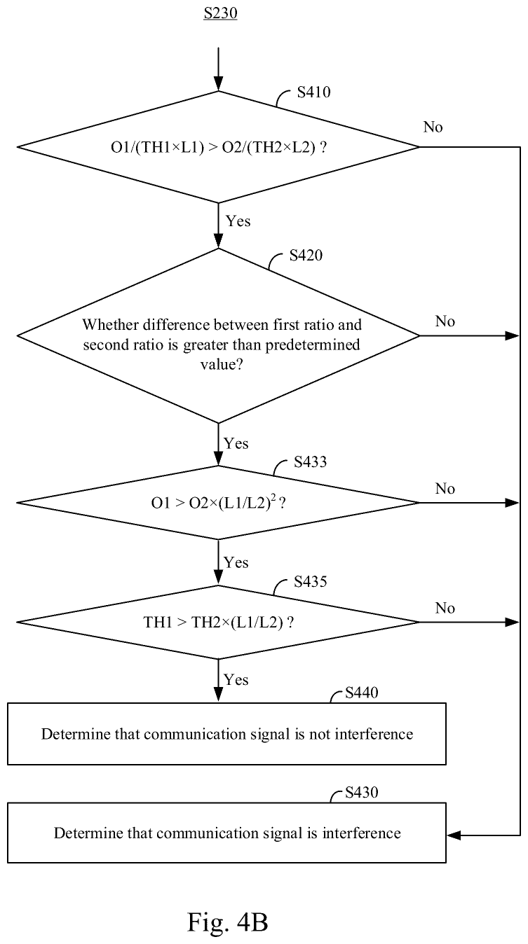

FIG. 4A illustrates a flowchart of the operation S230 in FIG. 2 according to some embodiments of the present disclosure. In this example, the processor circuit 120 is configured to compare a first ratio between the first delay correlation output value O1 and a first product with a second ratio between the second delay correlation output value O2 and a second product to determine whether the communication signal SIN is interference. The first product is the product of the first threshold value TH1 and the first period L1, and the second product is the product of the second threshold value TH2 and the second period L2.

In greater detail, in this example, operation S230 includes steps S410, S420, S430, and S440. In step S410, the first ratio between the first delay correlation output value and the first product is compared with the second ratio between the second delay correlation output value and the second product, where the first product is the product of the first threshold value and the first period, and the second product is the product of the second threshold value and the second period (represented in FIG. 4A as O1/(TH1×L1)>O2/(TH2×L2). If the first ratio is greater than the second ratio, step S420 is performed. If the first ratio is not greater than the second ratio, step S430 is performed. In step S420, whether the difference between the first and second ratios is greater than a predetermined value is determined. If this difference is greater than the predetermined value, step S440 is performed. If this difference is not greater than the predetermined value, step S430 is performed. In step S430, the communication signal is determined to be interference. In step S440, the communication signal is determined not to be interference.

It is understood that the first ratio O1/(TH1×L1) in step S410 corresponds to the value of the line segment 300 in FIG. 3, and the second ratio O2/(TH2×L2) in step S420 corresponds to the value of the line segment 310 in FIG. 3. As previously mentioned, after starting to receive the communication signal SIN, if the first ratio O1/(TH1×L1) is greater than the second ratio O2/(TH2×L2) and the difference between the first and second ratios is high (e.g., greater than a predetermined value), it indicates that the communication signal SIN may be a packet defined under the predetermined communication protocol. Under this condition, the processor circuit 120 may determine that the communication signal SIN is not interference. Alternatively, if the first ratio O1/(TH1×L1) is greater than the second ratio O2/(TH2×L2), but the difference between the first and second ratios is low (e.g., not greater than a predetermined value), or if the first ratio O1/(TH1×L1) is not greater than the second ratio O2/(TH2×L2), it indicates that the communication signal SIN is not a packet defined under the predetermined communication protocol. Under this condition, the processor circuit 120 may determine that the communication signal SIN is interference. Thus, through the above steps, the processor circuit 120 may utilize the first and second ratios O1/(TH1×L1) and O2/(TH2×L2), generated based on the first and second delay correlation information, to determine whether the communication signal SIN is interference. In some embodiments, the aforementioned predetermined value may be determined based on simulations and/or measurements and adjusted according to the requirements of the predetermined communication protocol. In some embodiments, operation S230 may not include step S420.

FIG. 4B illustrates a flowchart of operation S230 in FIG. 2 according to some embodiments of the present disclosure. Compared with FIG. 4A, in this example, operation S230 further includes steps S433 and S435. After executing step S420, if the difference is greater than the predetermined value, step S433 is performed. In step S433, whether the first delay correlation output value is greater than a first predetermined multiple of a second delay correlation output value by is determined, where the first predetermined multiple is the square of the ratio between the first and second periods (represented in FIG. 4B as O1>O2× (L1/L2)²). If the first delay correlation output value is not greater than the first predetermined multiple of the second delay correlation output value (i.e., (L1/L2)² in FIG. 4B), step S430 is performed. Alternatively, if the first delay correlation output value is greater than the first predetermined multiple of the second delay correlation output value, step S435 is performed.

For example, as shown in equations (2) and (4), the processor circuit 120 accumulates the output values C(t) of the delay correlation function by the first and second periods, respectively, and squares the accumulated results to generate the first and second delay correlation output values O1 and O2, respectively. Therefore, if the communication signal SIN is a valid signal, the first delay correlation output value O1 will be greater than the first predetermined multiple of the second delay correlation output value O2, where the first predetermined multiple is the square of the ratio between the first period L1 and the second period L2. For example, if the first period L1 is approximately 16 microseconds and the second period L2 is approximately 8 microseconds, the first predetermined multiple may be approximately 4 (i.e., (16/8)²). Hence, step S433 may be represented as O1>O2×4. If the first delay correlation output value O1 does not exceed the first predetermined multiple of the second delay correlation output value O2, it indicates that the communication signal SIN may be interference (i.e., step S430).

To explain it in another way, under ideal conditions (i.e., when the received communication signal SIN is a valid signal), the communication signal SIN described in equation (1) will satisfy the following relationship:

$${r}_{i , n} = {r}_{i , n - L 1}$$

$${r}_{i , n} \neq {r}_{i , n - L 2}$$

Under this condition, based on the previously mentioned equations (2) and (4), it may be derived that the first delay correlation output value O1 and the second delay correlation output value O2 satisfy the following relationship:

$$O 1 = {( {\sum }_{t = 0}^{L 1 - 1} C ( t ) )}^{2} = {( {\sum }_{t = 0}^{L 1 - 1} {r}_{i , n} \cdot {r}_{i , n - L 1}^{*} )}^{2} = {( {\sum }_{t = 0}^{L 1 - 1} {\vert {r}_{i , n} \vert}^{2} )}^{2}$$

$$O 2 = {( {\sum }_{t = 0}^{L 2 - 1} C ( t ) )}^{2} = {( {\sum }_{t = 0}^{L 2 - 1} {r}_{i , n} \cdot {r}_{i , n - L 2}^{*} )}^{2}$$

$$\to {\sum }_{n = t}^{L 1 + t - 1} {\vert {r}_{i , n} \vert}^{2} > ( \frac{L 1}{L 2} ) {\sum }_{n = t}^{L 2 + t - 1} {r}_{i , n} \cdot {r}_{i , n - L 2}^{*}$$

$$\to {( {\sum }_{t = 0}^{L 1 - 1} {\sum }_{n = t}^{L 1 + t - 1} {\vert {r}_{i , n} \vert}^{2} )}^{2} > {( {\sum }_{t = 0}^{L 2 - 1} {\sum }_{n = t}^{L 2 + t - 1} {r}_{i , n} \cdot {r}_{i , n - L 2}^{*} )}^{2} \times {( \frac{L 1}{L 2} )}^{2}$$

$$\to O 1 > O 2 \times {( \frac{L 1}{L 2} )}^{2}$$

From the above derivation, it is obtained that if the communication signal SIN is a valid signal, the first delay correlation output value O1 will be greater than the first predetermined multiple of the second delay correlation output value O2, where the first predetermined multiple is the square of the ratio between the first period L1 and the second period L2.

With continued reference to FIG. 4B, in step S435, whether the first threshold value TH1 is greater than a second predetermined multiple of the second threshold value TH is determined, where the second predetermined multiple is the ratio between the first period L1 and the second period L2 (represented in FIG. 4B as TH1>TH2× (L1/L2)). If the first threshold value TH1 is not greater than the second predetermined multiple of the second threshold value TH2 (i.e., in (L1/L2) FIG. 4B), step S430 is performed. Alternatively, if the first threshold value TH1 is greater than the second predetermined multiple of the second threshold value TH2, step S440 is performed.

For example, as shown in equations (3) and (5), the processor circuit 120 accumulates the square of the output values C(t) of the delay correlation function by the first period L1 and the second period L2, respectively, and outputs the accumulated results as the first threshold value TH1 and the second threshold value TH2. Therefore, if the communication signal SIN is a valid signal, the first threshold value TH1 will be greater than the second predetermined multiple of the second threshold value TH2, where the second predetermined multiple is the ratio between the first period L1 and the second period L2. For example, if the first period L1 is approximately 16 microseconds and the second period L2 is approximately 8 microseconds, the second predetermined multiple may be 2 (i.e., 16/8). Therefore, step S435 may be represented as TH1>TH2×2. If the first threshold value TH1 does not exceed the second predetermined multiple of the second threshold value TH2, it indicates that the communication signal SIN may be interference (i.e., step S430).

To explain it another way, as mentioned earlier, under ideal conditions (where the received communication signal SIN is a valid signal), the communication signal SIN described by equation (1) will satisfy the following relationship:

$${r}_{i , n} = {r}_{i , n - L 1}$$

$${r}_{i , n} \neq {r}_{i , n - L 2}$$

Under this condition, based on the previously mentioned equations (3) and (5), it may be derived that the first threshold value TH1 and the second threshold value TH2 satisfy the following relationship:

$$TH 1 = {\sum }_{t = 0}^{L 1 - 1} {C ( t )}^{2} = {\sum }_{t = 0}^{L 1 - 1} {( {\sum }_{n = t}^{L 1 + f - 1} {r}_{i , n} \cdot {r}_{i , n - L 1}^{*} )}^{2} = {\sum }_{t = 0}^{L 1 - 1} {( {\sum }_{n = t}^{L 1 + t - 1} {\vert {r}_{i , n} \vert}^{2} )}^{2}$$

$$TH 2 = {\sum }_{t = 0}^{L 2 - 1} {C ( t )}^{2} = {\sum }_{t = 0}^{L 2 - 1} {( {\sum }_{n = t}^{L 2 + t - 1} {r}_{i , n} \cdot {r}_{i , n - L 2}^{*} )}^{2}$$

$$\to {\sum }_{c = 0}^{L 1 - 1} {( {\sum }_{n = t}^{L 1 + t - 1} {\vert {r}_{i , n} \vert}^{2} )}^{2} > {\sum }_{t = 0}^{L 2 - 1} {( {\sum }_{n = t}^{L 2 + t - 1} {r}_{i , n} \cdot {r}_{i , n - L 2}^{*} )}^{2} \times ( \frac{L 1}{L 2} )$$

$$\to TH 1 > TH 2 \times ( \frac{L 1}{L 2} )$$

From the above derivation, it is understood that if the communication signal SIN is a valid signal, the first threshold value TH1 will be greater than a second predetermined multiple of the second threshold TH2, where the second predetermined multiple is the ratio between the first period L1 and the second period L2.

With steps S433 and S435, the processor circuit 120 may further determine whether the corresponding relationships between the first delay correlation output value O1, the second delay correlation output value O2, the first threshold value TH1, and the second threshold value TH2 are correct, in order to further enhance the detection accuracy. In different embodiments, the processor circuit 120 may be configured to perform at least one of steps S410, S420, S433, and/or S435 to determine whether the communication signal SIN is interference. The more steps that are performed, the more reference information are available for determining the nature of the communication signal SIN, leading to higher detection accuracy. In some embodiments, the number of steps being performed may be adjusted based on actual requirements (e.g., operation speed). Therefore, it is understood that the contemplated scope of the present disclosure is not limited to FIGS. 4A and 4B.

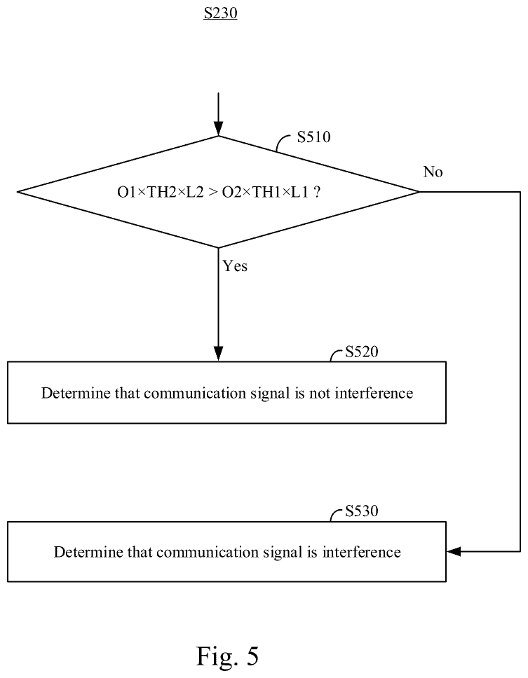

FIG. 5 illustrates a flowchart of operation S230 in FIG. 2 according to some embodiments of the present disclosure. Compared with FIG. 4A, in this example, the processor circuit 120 further determines whether the communication signal SIN is interference based on the first period L1, the second period L2, the first delay correlation information, and the second delay correlation information. In greater detail, the processor circuit 120 determines whether the communication signal SIN is interference according to a first product of the first delay correlation output value O1, the first product of the second threshold value TH2, and the second period L2, and a second product of the second delay correlation output value O2, the first threshold value TH1, and the first period L1.

For example, operation S230 includes steps S510, S520, and S530. In step S510, whether the first product of the first delay correlation output value O1, the second threshold value TH2, and the second period L2 is greater than the second product of the second delay correlation output value O2, the first threshold value TH1, and the first period L1 is determined (represented in FIG. 5 as O1×TH2×L2>O2×TH1×L1). If the first product O1×TH2×L2 is greater than the second product O2×TH1×L1, step S520 is performed. Alternatively, if the first product O1×TH2×L2 is not greater than the second product O2×TH1×L1, step S530 is performed. In step S520, the communication signal is determined not to be interference. In step S530, the communication signal is determined to be interference. As previously mentioned, step S410 in FIG. 4A may be expressed as O1/(TH1×L1)>O2/(TH2×L2). Through a simple derivation, step S410 may be reformulated as O1×TH2×L2>O2×TH1×L1 (which is the condition of step S510). Compared with step S410, the processor circuit 120 may only utilize multiplication operations to perform step S510, which may be more easily implemented in a circuit. If the first product O1×TH2×L2 is greater than the second product O2×TH1×L1, it indicates that the communication signal SIN is likely not to be interference. Alternatively, if the first product O1×TH2×L2 is not greater than the second product O2×TH1×L1, it indicates that the communication signal SIN is interference.

Similar to FIG. 4B, in the example of FIG. 5, the processor circuit 120 may also perform step S433 and/or step S435 in FIG. 4B to further improve detection accuracy. In various embodiments, the processor circuit 120 may be configured to perform at least one of steps S510, S420, S433, and/or S435 to determine whether the communication signal SIN is interference. Therefore, the contemplated scope of the present disclosure is not limited to FIGS. 4A, 4B, and 5.

The above steps shown in FIG. 4A, FIG. 4B, and FIG. 5 include exemplary steps, but those steps are not necessarily performed in the order described above. Steps of operation S230 may be added, replaced, changed order, and/or eliminated, or steps of operation S230 may be performed simultaneously or partially simultaneously as appropriate, in accordance with the spirit and scope of various embodiments of the present disclosure.

Mathematical models and/or related definitions of the delay correlation function, the first delay correlation output value O1, the second delay correlation output value O2, the first threshold value TH1, the second threshold value TH2, the first period L1, and the second period L2 provided in the above embodiments are given for illustrative purposes, and the present disclosure is not limited thereto. In some embodiments, additional parameters such as antenna weighting parameters, threshold correction parameters, etc., may be incorporated into the delay correlation function. Various delay correlation functions and delay correlation information that may be utilized for signal detection are within the contemplated scope of the present disclosure.

On the other hand, the values of the first period L1 and the second period L2 and types of predetermined communication protocols provided in the above embodiments are given for illustrative purposes, and the present disclosure is not limited thereto. The values of the first period L1 and the second period L2 may be set according to the predetermined communication protocol, and various predetermined communication protocols that may be employed for signal transmission are within the contemplated scope of the present disclosure.

As described above, a communication device and a valid signal detection method provided in some embodiments of the present disclosure may utilize the delay correlation function to determine whether the currently received communication signal is interference (even if the interference may be a periodic signal), thereby avoiding the reception of invalid signals.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications based on the claims of the present disclosure are all consequently viewed as being embraced by the scope of the present disclosure.

What is claimed is:

1. A communication device, comprising:
a receiver circuit configured to receive a communication signal; and
a processor circuit configured to utilize a first period to calculate a delay correlation function of the communication signal to determine a first delay correlation information, utilize a second period to calculate the delay correlation function of the communication signal to determine a second delay correlation information and determine whether the communication signal is interference according to the first delay correlation information and the second delay correlation information,
wherein the first period is greater than the second period.

2. The communication device of claim 1, wherein the first delay correlation information comprise a first delay correlation output value and a first threshold value, the second delay correlation information comprise a second delay correlation output value and a second threshold value, the processor circuit is configured to compare a first ratio between the first delay correlation output value and a first product with a second ratio between the second delay correlation output value and a second product to determine whether the communication signal is the interference, the first product is a product of the first threshold value and the first period, and the second product is a product of the second threshold value and the second period.

3. The communication device of claim 2, wherein if the first ratio is not greater than the second ratio, the processor circuit determines that the communication signal is the interference.

4. The communication device of claim 2, wherein if the first ratio is greater than the second ratio and a difference between the first ratio and the second ratio is not greater than a predetermined value, the processor circuit determines that the communication signal is the interference.

5. The communication device of claim 1, wherein the first delay correlation information comprise a first delay correlation output value and a first threshold value, the second delay correlation information comprise a second delay correlation output value and a second threshold value, the processor circuit further determines whether the communication signal is the interference according to a first product of the first delay correlation output value, the second threshold value, and the second period, and a second product of the second delay correlation output value, the first threshold value, and the first period.

6. The communication device of claim 5, wherein if the first product is not greater than the second product, the processor circuit determines that the communication signal is the interference.

7. The communication device of claim 1, wherein the first delay correlation information comprise a first delay correlation output value, the second delay correlation information comprise a second delay correlation output value, the processor circuit further determines whether the first delay correlation output value is greater than a predetermined multiple of the second delay correlation output value to determine whether the communication signal is the interference, and the predetermined multiple is a square of a ratio between the first period and the second period.

8. The communication device of claim 1, wherein the first delay correlation information comprise a first threshold value, the second delay correlation information comprise a second threshold value, and the processor circuit further determines whether the first threshold value is greater than a predetermined multiple of the second threshold value to determine whether the communication signal is the interference, and the predetermined multiple is a ratio between the first period and the second period.

9. The communication device of claim 1, wherein the first period is a period of a symbol in a preamble defined by a predetermined communication protocol.

10. The communication device of claim 9, wherein the predetermined communication protocol is IEEE 802.15.4.

11. A valid signal detection method, comprising:
utilizing a first period to calculate a delay correlation function of a communication signal to determine a first delay correlation information;
utilizing a second period to calculate the delay correlation function of the communication signal to determine a second delay correlation information, wherein the first period is greater than the second period; and
determining whether the communication signal is interference according to the first delay correlation information and the second delay correlation information.

12. The valid signal detection method of claim 11, wherein the first delay correlation information comprise a first delay correlation output value and a first threshold value, the second delay correlation information comprise a second delay correlation output value and a second threshold value, and determining whether the communication signal is the interference according to the first delay correlation information and the second delay correlation information comprises:
comparing a first ratio between the first delay correlation output value and a first product with a second ratio between the second delay correlation output value and a second product, in order to determine whether the communication signal is the interference,
wherein the first product is a product of the first threshold value and the first period, and the second product is a product of the second threshold value and the second period.

13. The valid signal detection method of claim 12, wherein comparing the first ratio between the first delay correlation output value and the first product with the second ratio between the second delay correlation output value and the second product, in order to determine whether the communication signal is the interference comprises:
determining that the communication signal is the interference if the first ratio is not greater than the second ratio.

14. The valid signal detection method of claim 12, wherein comparing the first ratio between the first delay correlation output value and the first product with the second ratio between the second delay correlation output value and the second product, in order to determine whether the communication signal is the interference comprises:
determining that the communication signal is the interference if the first ratio is greater than the second ratio and a difference between the first ratio and the second ratio is not greater than a predetermined value.

15. The valid signal detection method of claim 11, wherein the first delay correlation information comprise a first delay correlation output value and a first threshold value, the second delay correlation information comprise a second delay correlation output value and a second threshold value, and determining whether the communication signal is the interference according to the first delay correlation information and the second delay correlation information comprises:
determining whether the communication signal is the interference according to a first product of the first delay correlation output value, the second threshold value, and the second period, and a second product of the second delay correlation output value, the first threshold value, and the first period.

16. The valid signal detection method of claim 15, wherein determining whether the communication signal is the interference according to the first product of the first delay correlation output value, the second threshold value, and the second period, and the second product of the second delay correlation output value, the first threshold value, and the first period comprises:
determining that the communication signal is the interference if the first product is not greater than the second product.

17. The valid signal detection method of claim 11, wherein the first delay correlation information comprise a first delay correlation output value, the second delay correlation information comprise a second delay correlation output value, and determining whether the communication signal is the interference according to the first delay correlation information and the second delay correlation information comprises:
determining whether the first delay correlation output value is greater than a predetermined multiple of the second delay correlation output value, in order to determine whether the communication signal is the interference,
wherein the predetermined multiple is a square of a ratio between the first period and the second period.

18. The valid signal detection method of claim 11, wherein the first delay correlation information comprise a first threshold value, the second delay correlation information comprise a second threshold value, and determining whether the communication signal is the interference according to the first delay correlation information and the second delay correlation information comprises:
determining whether the first threshold value is greater than a predetermined multiple of the second threshold value by, in order to determine whether the communication signal is the interference,
wherein the predetermined multiple is a ratio between the first period and the second period.

19. The valid signal detection method of claim 11, wherein the first period is a period of a symbol in a preamble defined by a predetermined communication protocol.

20. The valid signal detection method of claim 19, wherein the predetermined communication protocol is IEEE 802.15.4.
